(19) United States
(12) Patent Application Publication
(10) Pub. No.: US 2006/0190536 A1
(43) Pub. Date: Aug. 24, 2006

(54) Method, system and program product for building social networks

(75) Inventors: Margaret A. Strong, Newnan, GA (US); Albert Tien Yuen Wong, Hacienda Heights, CA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/064,208

(22) Filed: Feb. 23, 2005

(51) Int. Cl. G06F 15/16

(52) U.S. Cl. 709/204

(57) ABSTRACT

Under the present invention, a user with an existing profile page who desires to have a social network built will first submit a subscription request. If approved, an existing contact list such as a chat list or the like for the user will be compared to existing contact lists for other subscribing users to establish commonalities. Based on such commonalities, a configurable social network of contacts is built. Using a graphical representation of the social network, the user can (among other things) provide or read testimonials about the contacts therein; access the profile pages for the contacts; provide or read “ratings” for the contacts; be provided with levels/degrees of separation between the contacts; validate trusts and business relationships, etc.

### FIELD OF THE INVENTION

The present invention generally relates to social networks. Specifically, the present invention relates to a method, system and program product for building social networks such as in highly matrixed organizations.

### BACKGROUND OF THE INVENTION

In a highly matrixed, geographically dispersed organization, the opportunity to cultivate social capital and build and cultivate social networks is limited. For example, once projects are completed, practitioners are often dispersed to other projects. Opportunities to foster the social and personal networks that often result in innovation and business opportunity are rare. Unlike the traditional office where relationships are nurtured and practitioners can mirror their experiences, building trust, in day-to-day, face-to-face interaction, the practitioner in a virtual world must often rely on untested references or only superficial relationships to ply social networks and establish a repoire with other practitioners.

The positive effects of sharing social capital and creating social networks have been studied in the social psychology and organizational psychology literature. A subset of these studies is social cognition, which is an area of psychology that studies the mental representation and processes that underlie people's perceptions, influence, and judgment of one another. Practitioners who work in a virtual world—one with limited, face-to-face contact, or practitioners who are widely dispersed have limited opportunity to expand these social networks. To underscore this point, the following conversation represents a traditional work situation:

Scene: A Golf Club; in the parking lot outside the clubhouse.

“Hi John!”

“Hi Mary—Mary, isn't it?? Gosh, it's been too long—it must be three years since we worked together on that xyz project?” “We both went through a lot of aspirin on that project together . . . hey, how'd your game go today?”

“Well, John, my swing suffered—I just couldn't concentrate. I kept on thinking about my client, who could really use an IT Optimization Assessment. I just can't seem to convince them, though. I need to bring in an expert. It's not my forte. But I'm not going to put anybody I don't know in front of my client.”

“You know, Mary, there's a guy here at the club who is really active in the ITS IT Optimization Community of Practice—he's a real “go-to” guy . . . .

“That's nice John, but I don't think much of those communities of practice . . . .

“Mary, are you kidding? That's where many of the distinguished engineers congregate.”

“Oh, wow, I had no idea the communities had become so credible.”

“Mary, let me ask this guy when you two can talk. He'll be able to tell exactly where you can go to find the expert you need.”

In this example, two practitioners accidentally met after a long hiatus. They immediately met on common ground—going through a tough project together. Trust was rekindled from this previous relationship—enough trust to dispel an inaccurate stereotype that Mary held regarding the credibility of communities of practice as a place to find the expert she needed to put in front of her client.

In the virtual world, practitioners often meet to work on projects and then return to their own cities. They rarely have an opportunity to “bump” into each other at the golf club, rekindle memories, swap current challenges, and discover a resource that is only a distant acquaintance for one as a solution for a client need for the other. In view of the foregoing, there exists a need for a method, system and program product for building social networks. Specifically a need exists for a system that leverages existing resources such as profile pages and contact lists (e.g., chat lists) to build social networks within an organization.

### SUMMARY OF THE INVENTION

In general, the present invention provides a method, system and program product for building social networks (e.g., in businesses). Specifically, under the present invention, a user with an existing profile page who desires to have a social network built will first submit a subscription request. If approved, an existing contact list such as a chat list or the like for the user will be compared to existing contact lists for other subscribing users to establish commonalities. Based on such commonalities, a configurable social network of contacts is built. Using a graphical representation of the social network, the user can (among other things) provide or read testimonials about the contacts therein; access the profile pages for the contacts; provide or read “ratings” for the contacts; be provided with levels/degrees of separation between the contacts; validate trusts and business relationships, etc.

A first aspect of the present invention provides a method for building social networks, comprising: receiving a subscription request from a user with a profile page; comparing an existing contact list of the user with existing contact lists of other subscribing users to determine commonalities between the existing contact list of the user and the existing contact lists of the other subscribing users; and building a configurable social network of contacts for the user based on the commonalities.

A second aspect of the present invention provides a method for building social networks, comprising: receiving a subscription request from a user with a profile page; comparing an existing contact list of the user with existing contact lists of other subscribing users to determine commonalities between the existing contact list of the user and the existing contact lists of the other subscribing users; building a configurable social network of contacts for the user based on the commonalities; generating a graphical representation of the configurable social network of contacts; receiving testimonials for one or more of the contacts in the configurable social network of contacts; receiving ratings for one or more of the contacts in the configurable social network of contacts; and identifying levels of separation between the contacts in the configurable social network of contacts.

A third aspect of the present invention provides a system for building social networks, comprising: a system for receiving a subscription request from a user with a profile page; a system for comparing an existing contact list of the user with existing contact lists of other subscribing users to determine commonalities between the existing contact list of the user and the existing contact lists of the other subscribing users; and a system for building a configurable social network of contacts for the user based on the commonalities.

A fourth aspect of the present invention provides a program product stored on a computer readable medium for building social networks, the computer readable medium comprising program code for performing the following steps: receiving a subscription request from a user with a profile page; comparing an existing contact list of the user with existing contact lists of other subscribing users to determine commonalities between the existing contact list of the user and the existing contact lists of the other subscribing users; and building a configurable social network of contacts for the user based on the commonalities.

A fifth aspect of the present invention provides a method for deploying an application for building social networks, comprising: providing a computer infrastructure being operable to: receive a subscription request from a user with a profile page; compare an existing contact list of the user with existing contact lists of other subscribing users to determine commonalities between the existing contact list of the user and the existing contact lists of the other subscribing users; and build a configurable social network of contacts for the user based on the commonalities.

A sixth aspect of the present invention provides computer software embodied in a propagated signal for building social networks, the computer software comprising instructions to cause a computer system to perform the following functions: receive a subscription request from a user with a profile page; compare an existing contact list of the user with existing contact lists of other subscribing users to determine commonalities between the existing contact list of the user and the existing contact lists of the other subscribing users; and build a configurable social network of contacts for the user based on the commonalities.

A seventh aspect of the invention provides a computer-readable medium that includes computer program code to enable a computer infrastructure to build social networks.

An eighth aspect of the invention provides a business method for building social networks.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for building social networks according to the present invention.

FIG. 2 shows an illustrative screen shot showing a profile page and a graphical representation of a social network according to the present invention.

FIG. 3 shows another portion of the profile page of FIG. 2.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a method, system and program product for building social networks (e.g., in businesses). Specifically, under the present invention, a user with an existing profile page who desires to have a social network built will first submit a subscription request. If approved, an existing contact list such as a chat list or the like for the user will be compared to existing contact lists for other subscribing users to establish commonalities. Based on such commonalities, a configurable social network of contacts is built. Using a graphical representation of the social network, the user can (among other things) provide or read testimonials about the contacts therein; access the profile pages for the contacts; provide or read “ratings” for the contacts; be provided with levels/degrees of separation between the contacts; validate trusts and business relationships, etc.

It should be understood in advance that the present invention is especially advantageous in building social networks in business organizations, especially highly matrixed organizations. Moreover, the present invention is especially advantageous in that it leverages existing data sources such as profile pages and contact lists to build the social networks. The present invention helps to establish and codify trusts, locate expertise, foster employee networking and involvement, provide immediate measurement for an employee's reputation/trust/relationships, etc. It should be understood in advance that the term “organization” is intended to refer to any grouping of individuals such as a business, on-line community, etc.

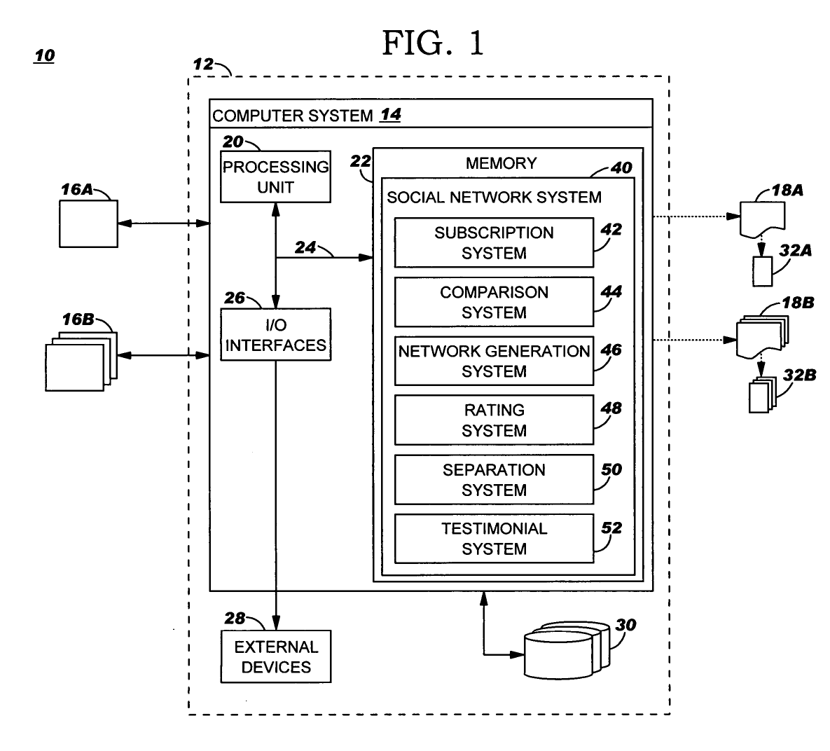

Referring now to FIG. 1, a system 10 for building social networks according to the present invention is shown. As depicted, system 10 includes a computer infrastructure 12, which comprises a computer system 14 that can perform the various process steps described herein. Computer system 14 is intended to represent any type of computer system capable of carrying out the teachings of the present invention. For example, computer system 14 could be a laptop computer, a desktop computer, a workstation, a handheld device, a server, etc. In addition, as will be further described below, computer system 14 can be deployed and/or operated by a service provider that is building social networks for users 16A-B. It should be appreciated that users 16A-B could directly access computer system 14, or could operating their own independent computer systems that communicate with computer system 14 over a network (e.g., the Internet, a wide area network (WAN), a local area network (LAN), a virtual private network (VPN), etc. In the case of the latter, communications between computer system 14 and the user-operated computer systems can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

In any event, assume that users 16A-B are a part of a common organization. Under the present invention, social networks among users 16A-B can be built. To provide this functionality, social network system 40 is shown implemented on computer system 14 as computer program code. To this extent, computer system 14 is shown including a processing unit 20, a memory 22, a bus 24, and an input/output (I/O) interfaces 26. Further, computer system 14 is shown in communication with external I/O devices/resources 28 and one or more storage systems 30. In general, processing unit 20 executes computer program code, such as social network system 40, that is stored in memory 22 and/or storage system(s) 30. While executing computer program code, processing unit 20 can read and/or write data, to/from memory 22, storage system(s) 30, and/or I/O interfaces 26. Bus 24 provides a communication link between each of the components in computer system 14. External devices 28 can comprise any devices (e.g., keyboard, pointing device, display, etc.) that enables a user to interact with computer system 14 and/or any devices (e.g., network card, modem, etc.) that enables computer system 14 to communicate with one or more other computing devices, such as those in organization 16.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer infrastructures that can include numerous combinations of hardware. For example, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interface 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. Such information can include, for example, profile pages, contact lists, graphical representations of social networks, ratings, levels/degrees of separation, testimonials, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14. Moreover, although not shown for brevity purposes, and computer systems operated by users 16A-B will likely contain computerized components similar to computer system 14.

Shown in memory 22 of computer system 14 is social network system 40, which includes subscription system 42, comparison system 44, network generation system 46, rating system 48, separation system 50 and testimonial system 52. Operation of each of these systems is discussed further below. However, it is understood that some of the various systems shown in FIG. 1 can be implemented independently, combined, and/or stored in memory for one or more separate computers systems 14 that communicate over a network. Further, it is understood that some of the systems/functionality may not be implemented and/or additional systems/functionality may be included as part of the present invention. Still yet, it is understood that the depiction of these systems shown in FIG. 1 is illustrative only and that the same functionality could be achieved with a different configuration. That is, the functionality of these systems could be combined into fewer systems, or broken down into additional systems.

Under the present invention such a social network can be built for any user 16A-B that has an existing profile page 18A-B. As known, many organizations allow their employees/members (e.g., users 16A-B) to create and post individual profile pages 18A-B. Such profile pages 18A-B can contain biographical information, pictures, interests, assigned departments, projects, etc. In addition, employees often create and maintain (electronic) contact lists 32A-B (which may or may not be a part of the profile pages). Under the present invention, chat lists are especially suited for building a social network. As will be further explained below, the present invention allows any user with a profile page to have a social network built for him/her based on the contact lists. It should be understood that although not shown, computer system 14 can have any software package now known or later developed for creating and maintaining such profile pages and contact lists.

In any event, assume in an illustrative example, that user 16A desires a social network to be built for him/her. In this case, user 16A will subscribe to this service via subscription system 42. In a typical embodiment, user 16A can subscribe by accessing his/her profile page 18A and selecting a subscribe button or the like. This will cause the subscription request to be generated, and received and processed by subscription system 42. In processing the subscription request, subscription system 42 can perform a validation such as ensuring user 16A is in fact a part of the corresponding organization. This can include, for example, checking user credentials against a directory of current members (e.g., an LDAP directory). Once user 16A has successfully subscribed, comparison system 44 will compare user 16A's existing contact list 32 to the existing contact lists 32B of other (subscribing) users 16B to determine commonalities there between. For example, contact lists 32B might have one or more contacts in common with contact list 32A. Such commonalities are determined by comparison system 44. It should be noted that although it is not necessary to limit the present invention to subscribing users, such an embodiment will allow individuals to opt-in or opt-out in the event they do no wish to be included in social networks. In any event, network generation system 46 will generate a social network of contacts based on the commonalities.

Under the present invention, network generation system 46 can generate the social network of contacts in any number of ways. For example, network generation system 46 could display the contacts in an order that is based on a “most in common” principle. For example, if contact “A” was in common to 100 contact lists, while contact “B” was in common to 80 contact lists, contact “A” could be displayed before contact “B” in the social network of contacts. In another embodiment, the contacts in common could be displayed in an order that is based on a recentness with which they were added (e.g., to the user 16A's contact list). For example, if contact “C” was in common with other users' contact list, and contact “C” was the most recently added contact to user 16A's contact list, then contact “C” could be displayed first. In another embodiment, the contacts could be displayed in an order according to common elements of the respective profiles. For example, assume that comparison system 44 initially determined contacts “A-G” to be in common between the users (including user 16A). Thereafter, comparison system 44 could compare elements the profiles (e.g., interests, field of work, etc.) for contacts “A-G” to the profile for user 16A. The contacts “A-G” could then be displayed in an order that is based on which profiles had the most elements in common to user 16A's profile. In still another embodiment, the manner in which the social network of contacts is displayed/arranged can be user configurable. For example, network generation system 46 could generate an interface page that allows user 16A to select or designate the manner in which the social network of contacts will be displayed. It should be understood that these are only a few examples of possible ways to build/arrange the social network of contacts. As such, the present invention is not intended to be limited thereto.

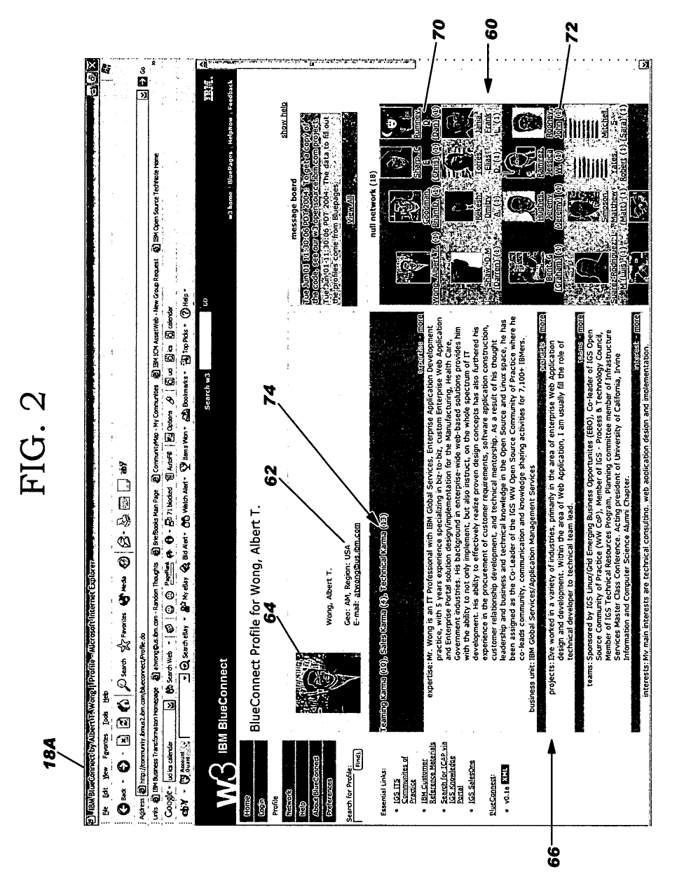

In any event, the social network of contacts can be presented to user 16A as a graphical representation on profile page 18A. Referring now to FIG. 2, profile page 18A is shown after a social network of contacts 60 has been generated. It should be understood that the graphical representation of social network of contacts 60 shown in FIG. 2 is not intended to be limiting. That is, social network of contacts 60 could be represented in any other format such as a hierarchical format, a list format, etc. To this extent, the use of pictures is also not necessary. Before social network of contacts 60 is further described, it can first be noted that profile page 18A can include any type of information about user 16A such as that described above. For example, profile page 18A may include biographical/contact information 62, a picture 64 of user 16A and background information 66 such as expertise, assigned department/business unit, projects, teams, interests, etc.

Regardless, in generating the graphical representation of the social network of contacts 60, network generation system 46 can include links 70 or the like to the profile pages of the respective contacts. In addition, under the present invention, social network of contacts 60 is highly configurable to provide many advantageous features. For example, by interfacing with network generation system 46 (FIG. 1), user 16A can add or remove one or more contacts therefrom. This allows user 16A to individually choose the make-up of his/her social network. In addition, rating system 48 (FIG. 1) is provided so that users 16A-B can read, submit and/or change ratings for one or more contacts in their social network of contacts 60. Specifically, as shown in FIG. 2, profile page 18A includes three (“karma”) ratings 74 (teaming, sales and technical) for user 16A. In a typical embodiment, ratings 74 are computed based on values submitted (via rating system 48) by other users/contacts (e.g., users 18B) with who user 16A has come in contact. This allows a quantitative type of feedback to be provided for any number of areas in which user 16A operates. If multiple users submit ratings for a single other user, the final ratings that are posted on the single user's profile page can be computed by rating system 48 using any known methodology. For example, the final ratings could be based on an average of all ratings submitted. In any event, if upon viewing social network of contacts 60 user 16A wishes to submit ratings for one or more of the contacts therein, he/she can do so via rating system 48.

Another “configurable” feature of the present invention is the capability to show levels/degrees of separation 72 between user 16A and the contacts in the social network 60. Specifically, because social network of contacts 60 will likely include contacts not present in user 16A's own contact list 32A, it is advantageous to known just how far user 16 is separated from each contact shown in social network of contacts 60. For example, a level of separation of “1” might correspond to a contact that is in fact present in user 16A's contact list 32A. Conversely, a level of separation of “2” might correspond to a contact that is not included in user 16A's contact list 32A, but is present in the contact list 32B of someone who is his/herself included in user 16A's contact list 32A. Such determinations can be made by separation system 50 after the comparison of contact lists or generation of social network of clients (but prior to its display).

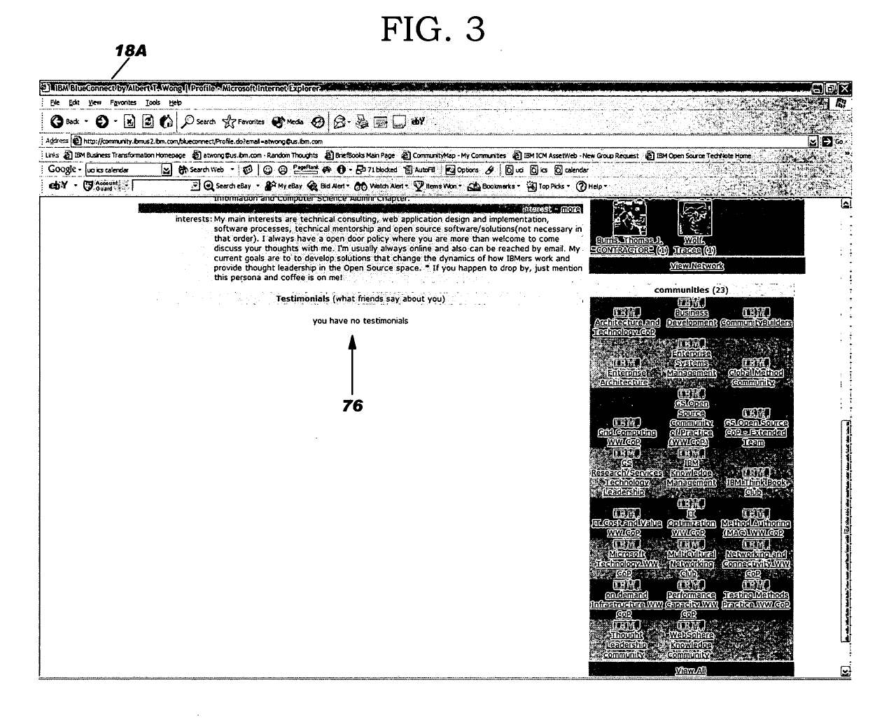

Still yet, testimonial system 52 of the present invention allows testimonials to be read, submitted and/or changed for one or more contacts in the social network of contacts 60. For example, referring to FIG. 3, profile page 18A for user 16A is continued. As depicted, there is a section 76 for testimonials. Although none have yet been provided for user 16A, any testimonials submitted by other users/contacts could be displayed in section 76. Thus, assume that user 16A wishes to submit a testimonial for contact “X” in social network of contacts 60 (FIG. 2). In this case, user 16A will interface with testimonial system 52 and provide the testimonial. To this extent, testimonial system 52 can provide an interface page that includes fields, text boxes or the like for which users 16A-B can submit the testimonials. Prior to their display on the respective users' profile pages 18A-B, however, all testimonials could be subject to approval by an administrator or the like to ensure appropriateness or some level of professionalism.

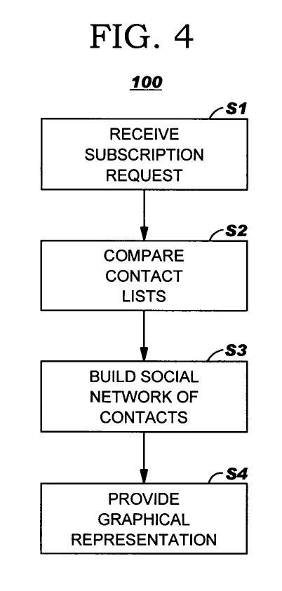

Referring now to FIG. 4, a method flow diagram 100 according to the present invention is shown. As depicted, first step SI is to receive a subscription request from a user who wishes to have a social network built. As mentioned above, this can be accomplished by selecting a “subscription” button or the like on his/her profile pages. Second step S2 is to compare an existing contact list for the user to existing contact lists for other subscribing users to determine commonalities. Third step S3 is to build a configurable social network of contacts based on the commonalities. Fourth step S4 is to provide a graphical representation of the social network of contacts to the user. The graphical representation can be provided in the user's profile page.

While shown and described herein as a method and system for building social networks, it is understood that the invention further provides various alternative embodiments. For example, in one embodiment, the invention provides a computer-readable medium that includes computer program code to enable a computer infrastructure to building social networks within organizations. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to build social networks as described above. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method of building social networks. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for building social networks, comprising:
receiving a subscription request from a user with a profile page;
comparing an existing contact list of the user with existing contact lists of other subscribing users to determine commonalities between the existing contact list of the user and the existing contact lists of the other subscribing users; and
building a configurable social network of contacts for the user based on the commonalities.

2. The method of claim 1, wherein the existing contact list of the user is present within the profile page, and wherein the existing contact lists of the other subscribing users are present in their respective profile pages.

3. The method of claim 1, further comprising generating a graphical representation of the configurable social network of contacts.

4. The method of claim 1, further comprising receiving testimonials for one or more of the contacts in the configurable social network of contacts.

5. The method of claim 1, further comprising receiving ratings for one or more of the contacts in the configurable social network of contacts.

6. The method of claim 1, further comprising identifying levels of separation between the contacts in the configurable social network of contacts.

7. The method of claim 1, further comprising providing, to the user, links to profile pages of the contacts in the configurable social network of contacts.

8. The method of claim 1, further comprising receiving a request to configure the configurable social network of contacts.

9. The method of claim 1, wherein the existing contact list of the user and the existing contact lists of the other subscribing users comprise chat lists.

10. A method for building social networks, comprising:
receiving a subscription request from a user with a profile page;
comparing an existing contact list of the user with existing contact lists of other subscribing users to determine commonalities between the existing contact list of the user and the existing contact lists of the other subscribing users;
building a configurable social network of contacts for the user based on the commonalities;
generating a graphical representation of the configurable social network of contacts;
receiving testimonials for one or more of the contacts in the configurable social network of contacts;
receiving ratings for one or more of the contacts in the configurable social network of contacts; and
identifying levels of separation between the contacts in the configurable social network of contacts.

11. A system for building social networks, comprising:
a system for receiving a subscription request from a user with a profile page;
a system for comparing an existing contact list of the user with existing contact lists of other subscribing users to determine commonalities between the existing contact list of the user and the existing contact lists of the other subscribing users; and
a system for building a configurable social network of contacts for the user based on the commonalities.

12. The system of claim 11, wherein the existing contact list of the user is present within the profile page, and wherein the existing contact lists of the other subscribing users are present in their respective profile pages.

13. The system of claim 11, further comprising a system for generating a graphical representation of the configurable social network of contacts.

14. The system of claim 13, wherein the graphical representation includes links to profile pages of the contacts in the configurable social network of contacts.

15. The system of claim 11, further comprising a system for receiving testimonials for one or more of the contacts in the configurable social network of contacts.

16. The system of claim 11, further comprising a system for receiving ratings for one or more of the contacts in the configurable social network of contacts.

17. The system of claim 11, further comprising a system for identifying levels of separation between the contacts in the configurable social network of contacts.

18. The system of claim 11, further comprising a system for receiving a request to configure the configurable social network of contacts.

19. The system of claim 11, wherein the existing contact list of the user and the existing contact lists of the other subscribing users comprise chat lists.

20. A program product stored on a computer readable medium for building social networks, the computer readable medium comprising program code for performing the following steps:
receiving a subscription request from a user with a profile page;
comparing an existing contact list of the user with existing contact lists of other subscribing users to determine commonalities between the existing contact list of the user and the existing contact lists of the other subscribing users; and
building a configurable social network of contacts for the user based on the commonalities.

21. The program product of claim 20, wherein the existing contact list of the user is present within the profile page, and wherein the existing contact lists of the other subscribing users are present in their respective profile pages.

22. The program product of claim 21, wherein computer readable medium further comprises program code for performing the following step: generating a graphical representation of the configurable social network of contacts.

23. The program product of claim 22, wherein the graphical representation includes links to profile pages of the contacts in the configurable social network of contacts.

24. The program product of claim 20, wherein computer readable medium further comprises program code for performing the following step: receiving testimonials for one or more of the contacts in the configurable social network of contacts.

25. The program product of claim 20, wherein computer readable medium further comprises program code for performing the following step: receiving ratings for one or more of the contacts in the configurable social network of contacts.

26. The program product of claim 20, wherein computer readable medium further comprises program code for performing the following step: identifying levels of separation between the contacts in the configurable social network of contacts.

27. The program product of claim 20, wherein computer readable medium further comprises program code for performing the following step: receiving a request to configure the configurable social network of contacts.

28. The program product of claim 20, wherein the existing contact list of the user and the existing contact lists of the other subscribing users comprise chat lists.

29. A method for deploying an application for building social networks, comprising:
providing a computer infrastructure being operable to:
receive a subscription request from a user with a profile page;
compare an existing contact list of the user with existing contact lists of other subscribing users to determine commonalities between the existing contact list of the user and the existing contact lists of the other subscribing users; and
build a configurable social network of contacts for the user based on the commonalities.
